(19) United States
(12) Patent Application Publication
(10) Pub. No.: US 2024/0061647 A1
(43) Pub. Date: Feb. 22, 2024

(54) INFORMATION PROCESSING APPARATUS, INFORMATION PROCESSING METHOD, AND PROGRAM

(71) Applicant: SONY GROUP CORPORATION, TOKYO (JP)

(72) Inventor: RYOTARO SHIRAI, TOKYO (JP)

(21) Appl. No.: 18/260,134

(22) PCT Filed: Nov. 22, 2021
(86) PCT No.: PCT/JP2021/042801

§ 371 Date: Jun. 30, 2023

(30) Foreign Application Priority Data
Jan. 8, 2021 (JP) 2021-002235

(51) Int. Cl. G06F 7/22; G06F 7/50

(52) U.S. Cl. CPC G06F 7/22; G06F 7/50

(57) ABSTRACT

[Object]

A calculation in which a natural number is expressed by four square numbers is performed at higher speed.

[Solving Means]

Provided is an information processing apparatus including a calculation unit that performs a calculation to express a certain natural number by the sum of a first square number, a second square number, a third square number, and a fourth square number. The calculation unit calculates, as the square root of the first square number, the largest value or a value smaller by two than the largest value among even numbers equal to or less than the square root of the natural number and then searches for the respective square roots of the second square number, the third square number, and the fourth square number.

### TECHNICAL FIELD

The present disclosure relates to an information processing apparatus, an information processing method, and a program.

### BACKGROUND ART

There has been known a calculation in which a certain natural number is expressed by the sum of four square numbers. Also, as described in NPL 1, there has been proposed a method for performing such a calculation at high speed.

### CITATION LIST

### Non Patent Literature

[NPL 1]

Kartikeya Bhardwaj, and one other person, “Finding the Four Squares in Lagrange's Theorem,” Mar. 16, 2018, [Online], [Searched on Dec. 24, 2020], Internet http://math.colgate.edu/˜integers/sjs15/sjs15.pdf>

### SUMMARY

### Technical Problem

However, according to the method described in Non Patent Literature, it takes approximately 2 ms on average to perform the calculation in the case where the bit length of the natural number is small, and it is hard to say it is sufficiently fast.

### Solution to Problem

According to one aspect of the present disclosure, there is provided an information processing apparatus including a calculation unit that performs a calculation to express a certain natural number by the sum of a first square number, a second square number, a third square number, and a fourth square number. The calculation unit calculates, as the square root of the first square number, the largest value or a value smaller by two than the largest value among even numbers equal to or less than the square root of the natural number and then searches for the respective square roots of the second square number, the third square number, and the fourth square number.

Also, according to another aspect of the present disclosure, there is provided an information processing method including, by a processor, performing a calculation to express a certain natural number by the sum of a first square number, a second square number, a third square number, and a fourth square number. The performing the calculation further includes calculating, as the square root of the first square number, the largest value or a value smaller by two than the largest value among even numbers equal to or less than the square root of the natural number and then searching for the respective square roots of the second square number, the third square number, and the fourth square number.

In addition, according to yet another aspect of the present disclosure, there is provided a program for causing a computer to function as an information processing apparatus including a calculation unit that performs a calculation to express a certain natural number by the sum of a first square number, a second square number, a third square number, and a fourth square number. The calculation unit calculates, as the square root of the first square number, the largest value or a value smaller by two than the largest value among even numbers equal to or less than the square root of the natural number and then searches for the respective square roots of the second square number, the third square number, and the fourth square number.

### BRIEF DESCRIPTION OF DRAWINGS

FIG. 1 is a block diagram illustrating a functional configuration example of an information processing apparatus 10 according to an embodiment of the present disclosure.

FIG. 2 is a flow chart illustrating an example of the flow of calculation using a first method according to the embodiment.

FIG. 3 is a flow chart illustrating an example of the flow of calculation using the first method according to the embodiment.

FIG. 4 is a block diagram illustrating an example of the flow of calculation control according to the embodiment which is performed on the basis of a natural number n.

FIG. 5 is a graph illustrating the relation between the calculation time and the bit length of the natural number n in the embodiment.

FIG. 6 is a sequence diagram illustrating an example of the flow of processing in the case where the information processing apparatus 10 according to the embodiment is used to create a CL signature certificate.

FIG. 7 is a block diagram illustrating a hardware configuration example of an information processing apparatus 90 according to the embodiment.

### DESCRIPTION OF EMBODIMENT

A preferred embodiment of the present disclosure will be described in detail below with reference to the accompanying drawings. It should be noted that, in the present specification and drawings, constituent elements having substantially the same functional configuration are denoted by the same reference signs, thereby omitting redundant description.

Note that the description will be given in the following order.
1. Embodiment
   1.1. Background
   1.2. Functional configuration example of information processing apparatus 10
   1.3. Details
   1.4. Application example
2. Hardware configuration example
3. Summary

### 1. Embodiment

### 1.1. Background

As mentioned above, there has been known a calculation in which a multiple-precision integer (any natural number) n is expressed as the sum of four square numbers. For example, a natural number n can be expressed by using four square numbers such that n=a²+b²+c²+d². As a specific example, 1506099439 can be represented by 38807²+337²+50²+11².

Examples of a method for performing the above calculation include an exhaustive method. In the calculation according to this method, an exhaustive search is conducted in the range [0, n^{1/2}] to determine three variables a, b, and c (d is determined automatically when a, b, and c are specified).

However, in the above method, since the exhaustive search is performed, the maximum amount of calculation is O(n^{3/2}). Therefore, even in the case where the natural number n has a bit length of 32 bits, which is a relatively small length, the calculation takes 36 minutes. Also, when a binary numerical value of an input value is large, the calculation time tends to increase.

For this reason, the calculation speed in the above method cannot be said to be high, and it is difficult to apply this method particularly to applications that use calculation results on a real time basis.

Further, since the above method does not take measures against timing attacks, there is a possibility that a value of the natural number n may undesirably be obtained by an attacker.

Meanwhile, there has also been proposed a computation method for performing at high speed a calculation involving the sum of four square numbers, as described in NPL 1, for example.

According to the method described in NPL 1, a high-speed calculation with a calculation amount of O((log n)²/(log log n)) can be achieved.

However, in the method described in NPL 1, even in the case where the natural number n is relatively small (10,000 or less), it takes approximately 2 ms on average to perform the calculation. Therefore, it is hard to say it's fast enough in the case of relatively small natural number n. In addition, the method described in NPL 1 uses a randomized algorithm, so that it takes approximately 3 ms to perform the calculation, in some cases.

Also, although the method described in NPL 1 can be said to be relatively strong against timing attacks using randomized algorithms, the calculation becomes extremely fast in the case where the natural number n is a power of 2. Therefore, further measures are required.

The technical idea according to one embodiment of the present disclosure has been conceived by focusing on the above points, and the object thereof is to enable a high-speed calculation regardless of the bit length of the natural number n in such a manner as to be resistant to timing attacks.

In a first method according to the embodiment of the present disclosure, in the case where the bit length of the natural number n is within 32 bits, a high-speed calculation of approximately 0.1 ms can be performed (in the case of using a high-end model among widely distributed processors at the time of filing application).

Further, in a second method according to the embodiment of the present disclosure, even in the case where the bit length of the natural number n is relatively large, a high-speed calculation with a calculation amount of O((log n)²/(log log n)) can be performed.

Further, in an information processing method that uses both the first method and the second method according to the embodiment of the present disclosure, such a calculation as to be resistant to timing attacks can be performed.

To be more specific, in the information processing method according to the embodiment of the present disclosure, even in the case where an attacker knows that the original natural number is either n or n+1 and also knows how long it takes to perform the calculation at a time, it is possible to output the result in such a manner that whether the original natural number is n or n+1 cannot be determined.

An example of the functional configuration for producing the above effects will be described below.

### 1.2. Functional Configuration Example of Information Processing Apparatus 10

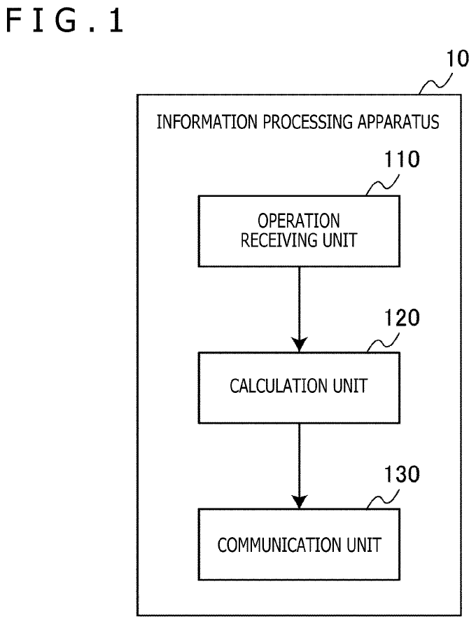

FIG. 1 is a block diagram illustrating a functional configuration example of an information processing apparatus 10 according to the present embodiment. As illustrated in FIG. 1, the information processing apparatus 10 according to the present embodiment may include an operation receiving unit 110, a calculation unit 120, and a communication unit 130.

(Operation Receiving Unit 110)

The operation receiving unit 110 according to the present embodiment accepts an operation from a user. For this purpose, the operation receiving unit 110 includes various input devices such as a keyboard, a mouse, a touch panel, and buttons.

(Calculation Unit 120)

The calculation unit 120 according to the present embodiment executes various calculations. In particular, the calculation unit 120 according to the present embodiment performs a calculation to express a certain natural number n by the sum of a first square number a², a second square number b², a third square number c², and a fourth square number d². At this time, the calculation unit 120 according to the present embodiment is characterized by particularly calculating, as the square root a of the first square number a², the largest value or a value smaller by two than the largest value among even numbers equal to or less than the square root √n of the natural number n, and then searching for the respective square roots (b, c, d) of the second square number b², the third square number c², and the fourth square number d².

According to such a feature of the calculation unit 120 as described above, in the case where the natural number n has a bit length of 32 bits, which is a relatively small length, a high-speed calculation of approximately 0.05 ms can be performed.

In addition, according to the above feature, even in the case where the bit length of the natural number n is relatively large, a relatively high-speed calculation with a calculation amount of O(n^{1/2}) can be performed.

Moreover, according to the above feature, such a calculation as to be resistant to timing attacks can be performed.

Functions of the calculation unit 120 according to the present embodiment are implemented by various processors. Details of the functions of the calculation unit 120 according to the present embodiment will be described later.

(Communication Unit 130)

The communication unit 130 according to the present embodiment communicates with and transmits information to other apparatuses via a wireless or wired network. As an example, the communication unit 130 according to the present embodiment transmits information including various results of the calculations by the calculation unit 120 to other apparatuses.

The functional configuration example of the information processing apparatus 10 according to the present embodiment has been described above. Note that the functional configuration described above with reference to FIG. 1 is merely an example, and the functional configuration of the information processing apparatus 10 according to the present embodiment is not limited to the example. For example, the information processing apparatus 10 according to the present embodiment may include, in addition to the configuration described above, a display unit for displaying various types of information or other units. The functional configuration of the information processing apparatus 10 according to the present embodiment may flexibly be modified according to specifications and operations.

### 1.3. Details

Next, the functions of the calculation unit 120 according to the present embodiment will be described in detail. First, the first method according to the present embodiment will be described. The first method according to the present embodiment is a method for calculating, as the square root a of the first square number a², the largest value or the value smaller by two than the largest value among even numbers equal to or less than the square root √n of the natural number n, and then searching for the respective square roots (b, c, d) of the second square number b², the third square number c², and the fourth square number d².

In a first usage according to the present embodiment, the calculation in which a certain natural number n is expressed by the sum of the first square number a², the second square number b², the third square number c², and the fourth square number d² can be performed with a calculation amount of O(n^{1/2}).

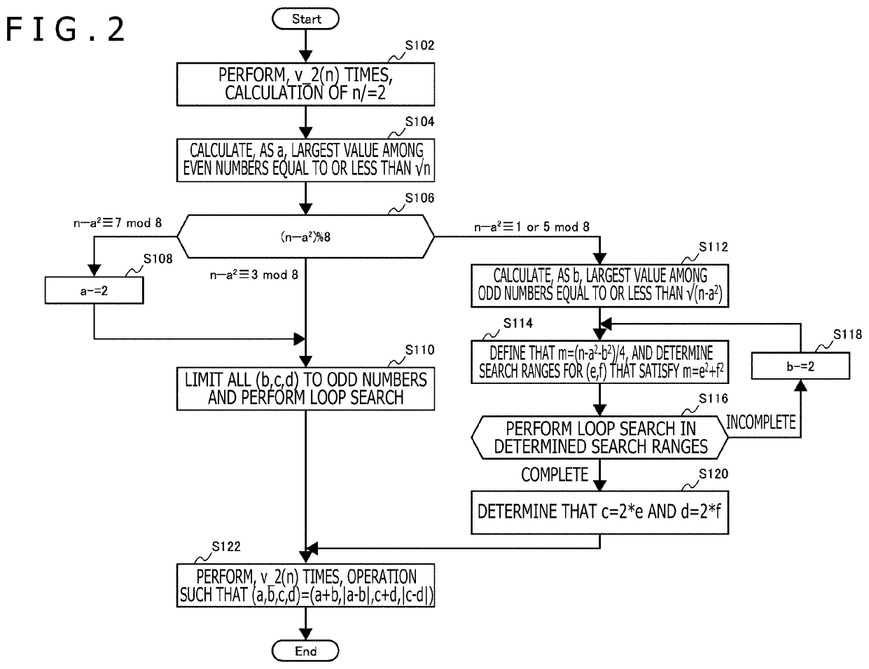

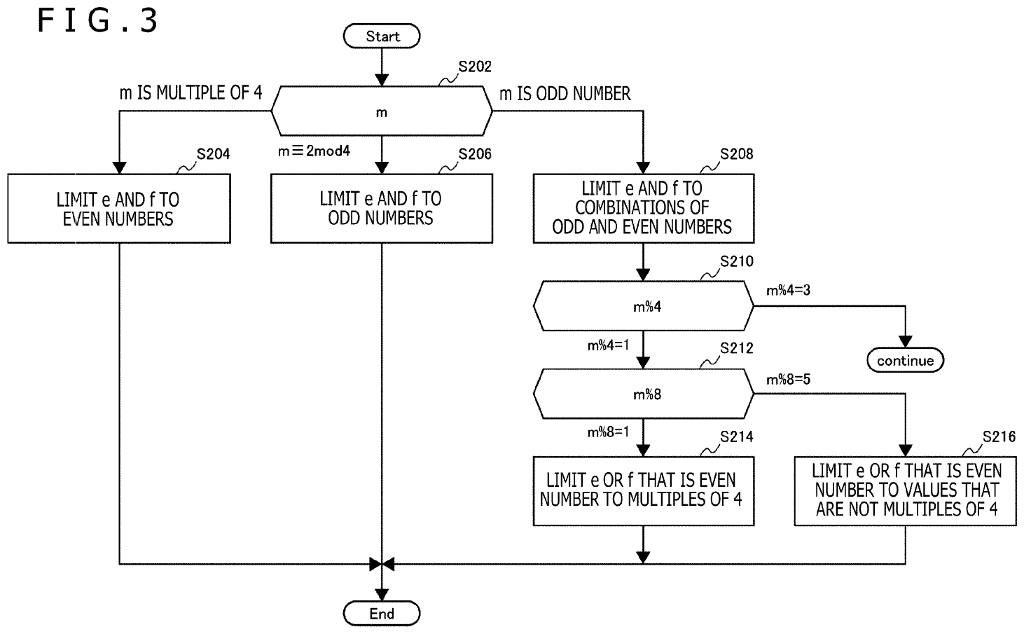

FIGS. 2 and 3 are each a flowchart illustrating an example of the flow of calculation using the first method according to the present embodiment.

First, description will be made with reference to FIG. 2. In the case of the example illustrated in FIG. 2, the calculation unit 120 first performs, v_2(n) times, the operation of n/=2 on the natural number n (S102).

That is, the calculation unit 120 performs a calculation to make as many divisions of the natural number n by two as possible.

Next, the calculation unit 120 calculates, as the square root a of the first square number a², the largest value or the value smaller by two than the largest value among even numbers equal to or less than the square root √n of the natural number n.

At this time, the calculation unit 120 may perform the calculation such that a=a (n−a²/≡7 mod 8) or a=a−2 (n−a²≡7 mod 8), where “/≡” is ≡congruence negation.

For example, the calculation unit 120 first calculates, as the square root a, a value among even numbers equal to or less than the square root √n of the natural number n (S104). In the case where the value obtained by subtracting the first square number a² from the natural number n is congruent to 7 modulo 8 (S106: n−a²=7 mod 8), the value that is smaller by two than the largest value among even numbers equal to or less than the square root √n of the natural number n may be calculated as the square root a of the first square number a² (S108).

After that, the calculation unit 120 searches for the square root b, the square root c, and the square root d that satisfy n−a²=b²+c²+d². At this time, the calculation unit 120 may determine different search ranges according to the value obtained by subtracting the first square number a² from the natural number n.

In the case where the value obtained by subtracting the first square number a² from the natural number n is congruent to 3 modulo 8 (S106: n−a²=3 mod 8) or congruent to 7 modulo 8 (S106: n−a²=7 mod 8), a loop search is performed while all of the search ranges for the respective square roots (b, c, d) of the second square number b², the third square number c², and the fourth square number d² are limited to odd numbers (S110).

On the other hand, in the case where the value obtained by subtracting the first square number a² from the natural number n is congruent to 1 or 5 modulo 8 (S106: n−a²=1 or 5 mod 8), the calculation unit 120 calculates, as b, the largest value among odd numbers equal to or less than Ain (S112).

Thus, when the square root b of the second square number b² is limited to an odd number, the value obtained by subtracting the first square number a² and the second square number b² from the natural number n, that is, (n−a²−b²), is a multiple of four.

Hence, the calculation unit 120 may determine the search ranges for the respective square roots (b, c, d) of the second square number b², the third square number c², and the fourth square number d², on the basis of the result of the calculation in which the value obtained by subtracting the first square number a² and the second square number b² from the natural number n is divided by four, that is, (m=(n−a²−b²)/4).

For example, the calculation unit 120 determines search ranges for coefficients e and f that satisfy m=e²+f² (S114), and performs loop search in the determined search ranges (S116).

Here, in the case where the coefficients e and f that satisfy m=e²+f² are not found (S116: incomplete), the calculation unit 120 calculates again, as b, a value that is smaller by two than the value calculated in step S112 (S118), and repeatedly executes the processing of steps S114 and S116.

On the other hand, in the case where the coefficients e and f that satisfy m=e²+f² are found (S116: complete), the calculation unit 120 may determine that the square root c of the third square number c² is twice the value of e (c=2*e) and that the square root d of the fourth square number d² is twice the value of f (d=2*f) (S120).

After that, the calculation unit 120 performs, on (a, b, c, d), an operation such that (a, b, c, d)=(a+b, |a−b|, c+d, |c−d|), v_2 (n) times (S122).

Next, with reference to FIG. 3, the flow of searching for the above coefficients e and f will be described in detail.

In the case where n−a²≡1 or 5 mod 8 is satisfied, the calculation unit 120 may determine different search ranges according to the result of m=(n−a²−b²)/4.

For this purpose, the calculation unit 120 first makes a determination on the basis of the value of m (S202).

Here, in the case where m is a multiple of four (S202: m is a multiple of four), the square root b of the second square number b² is an odd number, as described above. Further, in this case, both e=c/2 for the third square number c² and f=d/2 for the fourth square number d² are determined to be even numbers.

Hence, in the case where m is a multiple of four (S202: m is a multiple of four), the calculation unit 120 may limit the search range for the square root b of the second square number b² to odd numbers, and the search ranges for e and f to even numbers (S204).

On the other hand, in the case where m is congruent to 2 modulo 4 (S202: m=2 mod 4), both e and f are determined to be odd numbers.

Hence, in the case where m is congruent to 2 modulo 4 (S202: m=2 mod 4), the calculation unit 120 may limit the search range for the square root b of the second square number b² to odd numbers, and the search ranges for e and f to odd numbers (S206).

On the other hand, in the case where m is an odd number (S202: m is an odd number), e and f are a combination of odd and even numbers.

For this reason, in the case where m is an odd number (S202: m is an odd number), the calculation unit 120 may limit the search range for the square root b of the second square number b² to odd numbers, and the search ranges for e and f to combinations of odd and even numbers (S208).

Subsequently, the calculation unit 120 performs processing according to the remainder when m is divided by four (m % 4). For this reason, the calculation unit 120 makes a determination on the basis of the remainder (S210).

Here, in the case where the remainder when m is divided by four is three (S210: m % 4=3), the calculation unit 120 may exit from the series of steps illustrated in FIG. 3.

On the other hand, in the case where the remainder when m is divided by four is one (S210: m % 4=1), the calculation unit 120 subsequently makes a determination on the basis of the remainder when m is divided by eight (m % 8) (S212).

Here, in the case where the remainder when m is divided by eight is one (S212: m % 8=1), it is determined that e or f that is an even number is a multiple of four.

Hence, in the case where the remainder when m is divided by eight is one (S212: m % 8=1), the calculation unit 120 may limit the search range for e or f that is an even number, to multiples of four (S214).

On the other hand, in the case where the remainder when m is divided by eight is five (S212: m % 8=5), it is determined that e or f that is an even number is not a multiple of four.

Hence, in the case where the remainder when m is divided by eight is five (S212: m % 8==5), the calculation unit 120 may limit the search range for e or f that is an even number, to values that are not multiples of four (S216).

The flow of calculation using the first method according to the present embodiment has been described in detail above. In the first method according to the present embodiment, in the case where the natural number n has a bit length of 32 bits, which is a relatively small length, a high-speed calculation of approximately 0.05 ms can be achieved.

Moreover, in the first method according to the present embodiment, even in the case where the bit length of the natural number n is relatively large, such as 32 bits, a relatively high-speed calculation with a calculation amount of O(n^{1/2}) can be achieved.

Further, by adding a delay on the basis of the calculation time, such a calculation as to be resistant to timing attacks can be achieved.

However, when the first method according to the present embodiment and the method described in NPL 1 are compared, the first method is superior in the case where the bit length of the natural number n is relatively large, such as 32 bits, and in terms of strength against timing attacks, but the method described in NPL 1 is superior in the case where the bit length of the natural number n is relatively large, such as 32 bits.

For this reason, in the case where the bit length of the natural number n is equal to or less than a first threshold value, the calculation unit 120 according to the present embodiment may also perform a calculation by using the first method, in which the largest value or the value smaller by two than the largest value among even numbers equal to or less than the square root √n of the natural number n is determined as the square root a of the first square number a².

On the other hand, in the case where the bit length of the natural number n exceeds the first threshold, the calculation unit 120 according to the present embodiment may performs a calculation by using a second method for searching for the respective square roots of the first square number a, the second square number b, the third square number c, and the fourth square number d, with the use of a randomized algorithm.

As the second method for searching with the use of the randomized algorithm, the method described in NPL 1 may be adopted, for example.

Also, the first threshold may be set on the basis of such a bit length that the calculation time in the case of using the first method and the calculation time in the case of using the second method are substantially the same.

According to the processing as described above, a high-speed calculation can consistently be performed regardless of the bit length of the natural number n.

However, in the case where switching between the first method and the second method is performed simply on the basis of the bit length of the natural number n, a discrepancy in calculation time occurs near the bit length at which switching is performed.

Considering the above problem, the calculation unit 120 according to the present embodiment performs delay load processing to be described later, so that such a calculation as to be resistant to timing attacks can be performed.

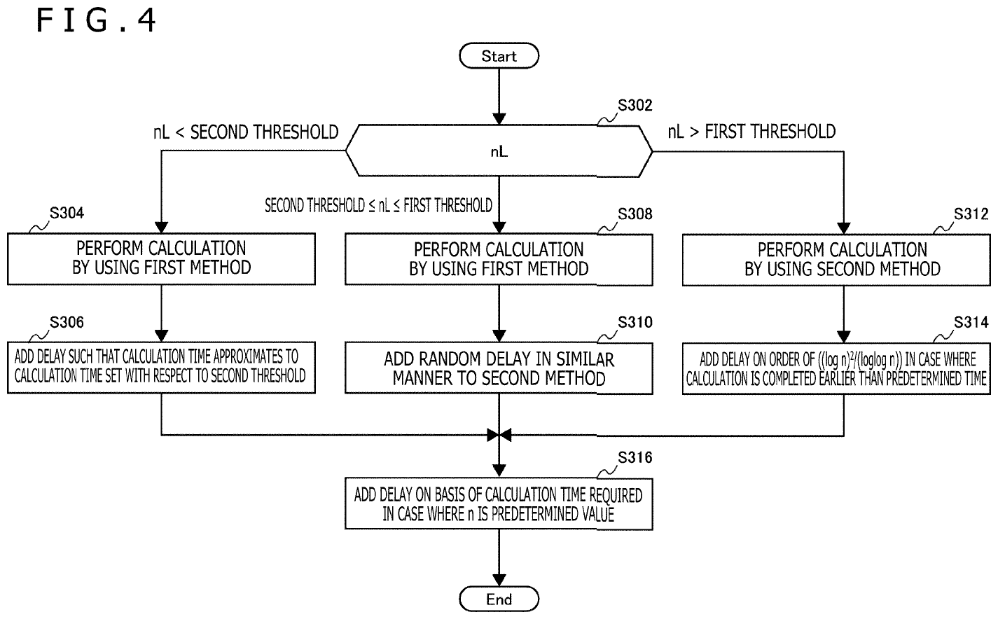

Here, calculation control according to the present embodiment which is performed on the basis of the bit length of the natural number n will be described in detail with reference to FIG. 4. FIG. 4 is a block diagram illustrating an example of the flow of the calculation control according to the present embodiment which is performed on the basis of the natural number n.

In the case of the example illustrated in FIG. 4, the calculation unit 120 first determines a bit length nL of the natural number n (S302).

Here, in the case where the bit length nL of the natural number n is less than a second threshold that is set on the basis of the first threshold (S302: nL<second threshold), the calculation unit 120 uses the first method to perform a calculation (S304).

The second threshold may be set on the basis of the first threshold. As an example, the second threshold may be approximately 20 bits less than the first threshold.

Next, the calculation unit 120 adds a delay such that the calculation time approximates to a calculation time set in advance with respect to the second threshold (S306). At this time, the calculation unit 120 may add the delay such that the calculation time with the delay added thereto satisfies the one-fourth power of n.

Also, in the case where the bit length nL of the natural number n is equal to or greater than the second threshold, which is set on the basis of the first threshold, but equal to or less than the first threshold (S302: second threshold nL first threshold), the calculation unit 120 performs a calculation by using the first method (S308).

Next, the calculation unit 120 adds a random delay in a similar manner to the second method (S310).

On the other hand, in the case where the bit length nL of the natural number n exceeds the first threshold (S302: nL>first threshold), the calculation unit 120 performs a calculation by using the second method (S312).

Here, in the case where the calculation using the second method is completed earlier than a predetermined time, the calculation unit 120 adds a delay on the order of ((log n)²/(log log n)) (S314).

Further, after the processing in steps S306, S310, and S314, the calculation unit 120 may further adds a delay on the basis of a calculation time required in the case where the bit length nL of the natural number n has a predetermined value (for example, a delay of 0% to 100% of the calculation time) (S316).

The example of the flow of the calculation control according to the present embodiment which is performed on the basis of the natural number n has been described above in detail. Next, the effect exhibited by the calculation control according to the present embodiment which is performed on the basis of the natural number n will be described.

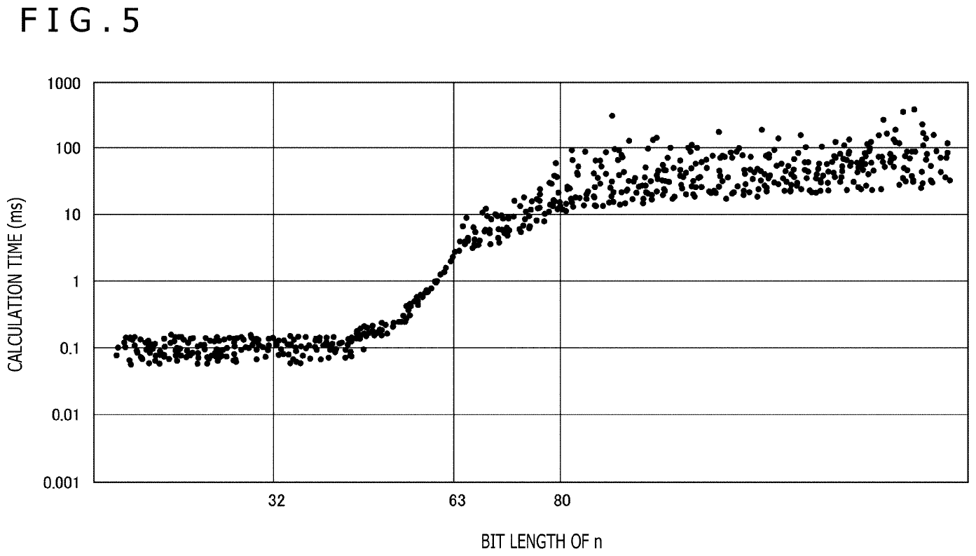

FIG. 5 is a graph illustrating the relation between the calculation time and the bit length of the natural number n in the present embodiment. In the graph illustrated in FIG. 5, the horizontal axis indicates the bit length of the natural number n, and the vertical axis indicates the calculation time required for the calculation unit 120. In the graph, both the bit length and the calculation time are indicated by using logarithms. Also, the graph illustrated in FIG. 5 represents the output result when the calculation is performed with the first threshold set to 80 bits and the second threshold set to 63 bits.

Referring to the graph illustrated in FIG. 5, it can be seen that the plots are generally appearing successively. This indicates that, even in the case where an attacker illegally obtains the calculation time, it is difficult to determine the original natural number from the calculation time.

Further, focusing on the vicinity of 80 bits, which is the first threshold where switching between the first method and the second method is performed, it can be seen that the distribution of the calculation time does not change around 80 bits. This indicates that it is difficult for the attacker to identify the switching of the calculation methods.

Further, focusing on the range of 32 bits or less, in which the bit length nL of the natural number n is relatively small, it can be seen that the calculation time is approximately 0.1 ms in this range. This indicates that a sufficiently high-speed calculation is achieved by a first retribution according to the present embodiment.

### 1.4. Application Example

Next, an application example of the information processing apparatus 10 according to the present embodiment will be described by way of example.

The information processing apparatus 10 according to the present embodiment can be used to create a CL signature certificate, for example.

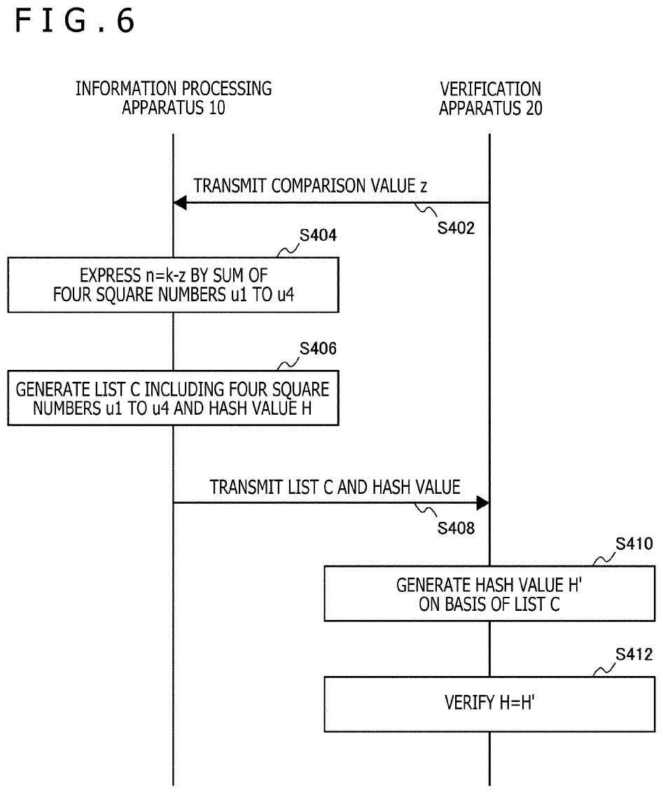

FIG. 6 is a sequence diagram illustrating an example of the flow of processing in the case where the information processing apparatus 10 according to the present embodiment is used to create a CL signature certificate.

In the case of the example illustrated in FIG. 6, first, a verification apparatus 20 transmits a comparison value z to the information processing apparatus 10 (S402).

Here, the above comparison value z can be any of various values that serve as references for verification by the verification apparatus 20.

For example, assumed herein is the case where the verification by the verification apparatus 20 is age verification which is conducted when a person is to purchase alcoholic beverages. In this case, the comparison value z may be a value indicating the age at which a person is permitted to purchase alcoholic beverages in a certain country or region

As an example, in Japan, the legal drinking age at which a person is legally permitted to purchase alcoholic beverages is 20 years old. Hence, here, the comparison value z may be 20.

Next, the calculation unit 120 of the information processing apparatus 10 defines, as the natural number n, the difference between the comparison value z, which is received by the communication unit 130 in step S402, and a confidential value k, and performs a calculation to express the natural number n by the sum of four square numbers u1 to u4 (S404).

Here, the confidential value k may be a value to be compared with the comparison value z, and may be a value that a prover who operates the information processing apparatus 10 intends to keep confidential.

For example, in the case where a person is to purchase alcoholic beverages as mentioned above, the confidential value k may be a value indicating the age of the person, i.e., the prover. As an example, in the case where the prover is 25 years old, the confidential value k may be 25.

In this case, since the natural number n is equal to or less than the first threshold, the calculation unit 120 uses the first method to perform a calculation such that n=k−z=25−20=5=2²+1²+0²+0².

Alternately, for example, the comparison value z transmitted by the verification apparatus 20 and the confidential value k held by the information processing apparatus 10 may be expressed in UNIX (registered trademark) time.

Here, in the case where the comparison value z is a value expressing the date of 2020 in UNIX time and where the confidential value k is a value expressing the date of birth of the prover in UNIX time, n=k−z can take any natural number in the 64-bit range.

In this case, the calculation unit 120 performs a calculation by using the second method, because the natural number n exceeds the first threshold.

Next, the calculation unit 120 generates a list C={w^{ui}*s^{ri}} (I=1 to 4) containing information regarding the four square numbers u1 to u4, which are calculated in step S404, and a hash value H=H (w^{u}*, G, r) (S406).

Here, w and s in the above denote public keys, ri and r denote random values, and σ denotes a prewritten signature for the confidential value k.

Next, the communication unit 130 of the information processing apparatus 10 transmits the list C and the hash value H generated by the calculation unit 120 in step S406 to the verification apparatus 20 (S408).

Next, the verification apparatus 20 generates a hash value H′ on the basis of the list C received in step S408 (S410).

Then, the verification apparatus 20 verifies whether or not the hash value H received in step S408 and the hash value H′ generated in step S410 satisfy H=H′ (S412).

Here, in the case where H=H′ is satisfied, it is guaranteed that the confidential value k is equal to or greater than the comparison value z.

On the other hand, in the case where H=H′ is not satisfied, the verification apparatus 20 may reject the request from the prover.

The application example of the information processing apparatus 10 according to the present embodiment has specifically been described above by way of example. As described above, the first square number a², the second square number b², the third square number c², and the fourth square number d² output by the calculation unit 120 according to the present embodiment may be used to verify the confidential value k.

According to the processing described above, the prover can prove that the confidential value k is greater than the presented comparison value z, without disclosing the value of the confidential value k.

Further, with the information processing apparatus 10 according to the present embodiment, since calculations relating to four square numbers can be performed at high speed, the information processing apparatus 10 can be widely applied to systems that require interactivity and real-time performance as described above.

### 2. Hardware Configuration Example

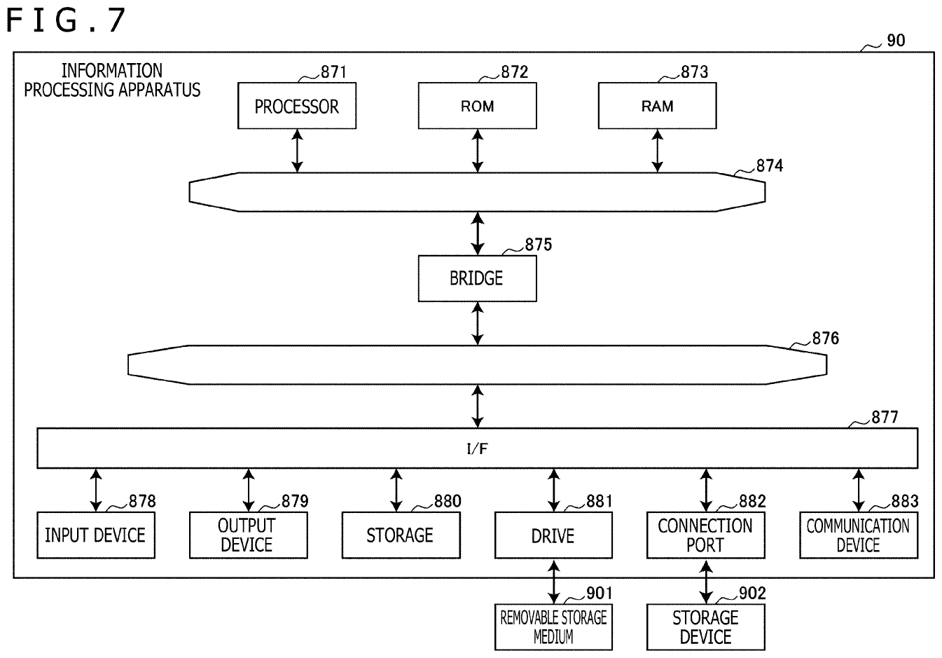

Next, a hardware configuration example of the information processing apparatus 10 according to the one embodiment of the present disclosure will be described. FIG. 7 is a block diagram illustrating a hardware configuration example of an information processing apparatus 90 according to the one embodiment of the present disclosure. The information processing apparatus 90 may be an apparatus having a hardware configuration equivalent to that of the information processing apparatus 10. As illustrated in FIG. 7, the information processing apparatus 90 includes, for example, a processor 871, a ROM 872, a RAM 873, a host bus 874, a bridge 875, an external bus 876, an interface 877, an input device 878, and an output device 879, a storage 880, a drive 881, a connection port 882 and a communication device 883. Note that the hardware configuration illustrated here is an example and that some of the components may be omitted. Moreover, it may further include components other than the components illustrated here.

(Processor 871)

The processor 871 functions as, for example, an arithmetic processing device or a control device, and controls the overall operation or a part thereof of each component on the basis of various programs recorded in the ROM 872, the RAM 873, the storage 880, or a removable storage medium 901.

(ROM 872, RAM 873)

The ROM 872 is means for storing, for example, programs to be read by the processor 871 and data used for calculations. The RAM 873 temporarily or permanently stores programs to be read by the processor 871 and various parameters that change appropriately when the programs are executed, for example.

(Host bus 874, Bridge 875, External bus 876, Interface 877)

The processor 871, the ROM 872, and the RAM 873 are interconnected via the host bus 874 capable of high-speed data transmission, for example. Meanwhile, the host bus 874 is connected via the bridge 875 to the external bus 876 with a relatively low data transmission speed, for example. Further, the external bus 876 is connected to various components via the interface 877.

(Input Device 878)

As the input device 878, a mouse, a keyboard, a touch panel, buttons, switches, and levers are used, for example. Further, as the input device 878, a remote controller (hereinafter referred to as a Rimo-con) capable of transmitting control signals by using infrared rays or other radio waves may be used. Further, the input device 878 includes a voice input device such as a microphone.

(Output Device 879)

The output device 879 is a device capable of visually or audibly notifying a user of the acquired information. For example, the output device 879 is a display device such as a CRT (Cathode Ray Tube), an LCD, or an organic EL, an audio output device such as a speaker or headphones, a printer, a mobile phone, or a facsimile. In addition, the output device 879 according to the present disclosure also include various vibration devices capable of outputting tactile stimuli.

(Storage 880)

The storage 880 is a device for storing various types of data. As the storage 880, a magnetic storage device such as a hard disk drive (HDD), a semiconductor storage device, an optical storage device, or a magneto-optical storage device, for example, is used.

(Drive 881)

The drive 881 is a device that reads information recorded in the removable storage medium 901 such as a magnetic disk, an optical disk, a magneto-optical disk, or a semiconductor memory, or that writes information to the removable storage medium 901, for example.

(Removable Storage Medium 901)

The removable storage medium 901 is a DVD medium, a Blu-ray (registered trademark) medium, an HD DVD medium, or various types of semiconductor storage media, for example. Needless to say, the removable storage medium 901 may be an IC card equipped with a contactless IC chip or may be an electronic device, for example.

(Connection Port 882)

The connection port 882 is a port to which an external connection device 902 is connected, such as a USB (Universal Serial Bus) port, an IEEE1394 port, an SCSI (Small Computer System Interface), an RS-232C port, or an optical audio terminal.

(External Connection Device 902)

The external connection device 902 is a printer, a portable music player, a digital camera, a digital video camera, or an IC recorder, for example.

(Communication Device 883)

The communication device 883 is a communication device for connecting to a network, such as a communication card for a wired or wireless LAN, for Bluetooth (registered trademark), or for a WUSB (Wireless USB), a router for optical communication, a router for ADSL (Asymmetric Digital Subscriber Line), or a modem for various types of communication.

### 3. Summary

As described above, the calculation unit 120 according to the one embodiment of the present disclosure performs a calculation to express a certain natural number n by the sum of the first square number a², the second square number b², the third square number c², and the fourth square number d². Further, in particular, the calculation unit 120 according to the present embodiment is characterized by calculating, as the square root a of the first square number a², the largest value or the value smaller by two than the largest value among even numbers equal to or less than the square root √n of the natural number n, and then searching for the respective square roots (b, c, d) of the second square number b², the third square number c², and the fourth square number d².

According to the above configuration, calculations in which a natural number is expressed by using four square numbers can be performed at a higher speed.

Although the preferred embodiment of the present disclosure has been described in detail above with reference to the accompanying drawings, the technical scope of the present disclosure is not limited to such an example as described above. It is obvious that a person having ordinary knowledge in the technical field of the present disclosure can conceive various alterations or modifications within the scope of the technical idea described in the claims, and thus, it is understood that these alterations or modifications are also naturally within the technical scope of the present disclosure.

Further, the respective steps related to the processing described in the present specification do not necessarily have to be performed in chronological order according to the order described in the flowcharts and sequence diagrams. For example, the respective steps related to the processing by each apparatus may be performed in an order different from that described above, or may be performed in parallel.

Also, a series of processing steps performed by each apparatus as described in the present specification may be performed by using any of software, hardware, and a combination of software and hardware. A program that constitutes software is, for example, stored in advance in a non-transitory computer readable medium which is provided in the inside or outside of each apparatus. Then, for example, each program is read into a RAM when being executed by a computer, and is then executed by various processors. The above storage medium is a magnetic disk, an optical disk, a magneto-optical disk, or a flash memory, for example. Also, the above computer program may be distributed, for example, via a network without using a storage medium.

Also, the effects described herein are merely illustrative or exemplary, and effects are not limited to the above effects. In other words, the technology according to the present disclosure can produce, in addition to or instead of the above effects, other effects that are obvious to those skilled in the art from the description of the present specification.

It should be noted that the technical scope of the present disclosure also covers the following configurations.

(1)

An information processing apparatus including:
a calculation unit that performs a calculation to express a certain natural number by a sum of a first square number, a second square number, a third square number, and a fourth square number,
the calculation unit being configured to calculate, as a square root of the first square number, a largest value or a value smaller by two than the largest value among even numbers equal to or less than a square root of the natural number and then search for respective square roots of the second square number, the third square number, and the fourth square number.
   (2)

The information processing apparatus according to (1) described above, in which,
in a case where a value obtained by subtracting the first square number from the natural number is congruent to 1 or 5 modulo 8, the calculation unit limits a search range for the square root of the second square number to odd numbers and then determines search ranges for the respective square roots of the third square number and the fourth square number, on the basis of a resultant value obtained by dividing, by four, a value obtained by subtracting the first square number and the second square number from the natural number.
   (3)

The information processing apparatus according to (2) described above, in which,
in a case where the resultant value obtained by dividing, by four, the value obtained by subtracting the first square number and the second square number from the natural number is a multiple of four, the calculation unit limits the search range for the square root of the second square number to odd numbers and limits search ranges for a coefficient for the square root of the third square number and a coefficient for the square root of the fourth square number to even numbers.
   (4)

The information processing apparatus according to (2) described above, in which,
in a case where the resultant value obtained by dividing, by four, the value obtained by subtracting the first square number and the second square number from the natural number is congruent to 2 modulo 4, the calculation unit limits the search range for the square root of the second square number to odd numbers and limits search ranges for a coefficient for the square root of the third square number and a coefficient for the square root of the fourth square number to odd numbers.
   (5)

The information processing apparatus according to (2) described above, in which,
in a case where the resultant value obtained by dividing, by four, the value obtained by subtracting the first square number and the second square number from the natural number is an odd number, the calculation unit limits search ranges for a coefficient for the square root of the third square number and a coefficient for the square root of the fourth square number to combinations of odd and even numbers.
   (6)

The information processing apparatus according to (5) described above, in which,
in a case where a remainder when the value obtained by subtracting the first square number and the second square number from the natural number is divided by four is one and where a remainder when the value obtained by subtracting the first square number and the second square number from the natural number is divided by eight is one, the calculation unit limits the search range for one of the coefficient for the square root of the third square number and the coefficient for the square root of the fourth square number that is an even number, to multiples of four.
   (7)

The information processing apparatus according to (5) described above, in which,
in a case where a remainder when the value obtained by subtracting the first square number and the second square number from the natural number is divided by four is one and where a remainder when the value obtained by subtracting the first square number and the second square number from the natural number is divided by eight is five, the calculation unit limits the search range for one of the coefficient for the square root of the third square number and the coefficient for the square root of the fourth square number that is an even number, to values that do not include multiples of four.
   (8)

The information processing apparatus according to (1) described above, in which,
in a case where a value obtained by subtracting the first square number from the natural number is congruent to 3 or 7 modulo 8, the calculation unit limits search ranges for the square root of the second square number, the square root of the third square number, and the square root of the fourth square number to odd numbers.
   (9)

The information processing apparatus according to any one of (1) to (8) described above, in which,
in a case where a bit length of the natural number is equal to or less than a first threshold, the calculation unit performs a calculation by using a first method for calculating, as the square root of the first square number, the largest value or the value smaller by two than the largest value among the even numbers equal to or less than the square root of the natural number.
   (10)

The information processing apparatus according to (9) described above, in which,
in a case where the bit length of the natural number exceeds the first threshold, the calculation unit performs a calculation by using a second method for searching for the respective square roots of the first square number, the second square number, the third square number, and the fourth square number with use of a randomized algorithm.
   (11)

The information processing apparatus according to (10) described above, in which
the first threshold is set on the basis of a bit length at which a calculation time taken in a case where the first method is used and a calculation time taken in a case where the second method is used are substantially identical to each other.
   (12)

The information processing apparatus according to (11) described above, in which,
in a case where the bit length of the natural number is less than a second threshold that is set on the basis of the first threshold, the calculation unit adds a delay such that the calculation time approximates to a calculation time set in advance with respect to the second threshold, and then outputs a result of the calculation using the first method.
   (13)

The information processing apparatus according to (11) described above, in which,
in a case where the bit length of the natural number is equal to or greater than a second threshold that is set on the basis of the first threshold but equal to or less than the first threshold, the calculation unit adds a random delay in a similar to the second method and then outputs a result of the calculation using the first method.
   (14)

The information processing apparatus according to (11) described above, in which,
in a case where the bit length of the natural number exceeds the first threshold and where the calculation using the second method is completed earlier than a predetermined time, the calculation unit adds a delay on an order of ((log n)²/(log log n)) (where n represents the natural number) and then outputs a result of the calculation using the second method.
   (15)

The information processing apparatus according to (10) described above, in which
the calculation unit adds a delay on the basis of a calculation time required in a case where the bit length of the natural number has a predetermined value, and then outputs a result of the calculation using the first method or the second method.
   (16)

The information processing apparatus according to any one of (1) to (15) described above, in which
the calculation unit performs a calculation by using, as the natural number, a difference between a received comparison value and a predetermined confidential value.
   (17)

The information processing apparatus according to (16) described above, in which
the first square number, the second square number, the third square number, and the fourth square number that are output by the calculation unit are used to verify the confidential value.
   (18)

An information processing method including:
by a processor,
performing a calculation to express a certain natural number by a sum of a first square number, a second square number, a third square number, and a fourth square number, in which
the performing the calculation further includes calculating, as a square root of the first square number, a largest value or a value smaller by two than the largest value among even numbers equal to or less than a square root of the natural number and then searching for respective square roots of the second square number, the third square number, and the fourth square number.
   (19)

A program for causing a computer to function as:
an information processing apparatus including
   a calculation unit that performs a calculation to express a certain natural number by a sum of a first square number, a second square number, a third square number, and a fourth square number,
   the calculation unit being configured to calculate, as a square root of the first square number, a largest value or a value smaller by two than the largest value among even numbers equal to or less than a square root of the natural number and then search for respective square roots of the second square number, the third square number, and the fourth square number.

### REFERENCE SIGNS LIST

10: Information processing apparatus
110: Operation receiving unit
120: Calculation unit
130: Communication unit
20: Verification apparatus

1. An information processing apparatus comprising:
a calculation unit that performs a calculation to express a certain natural number by a sum of a first square number, a second square number, a third square number, and a fourth square number,
the calculation unit being configured to calculate, as a square root of the first square number, a largest value or a value smaller by two than the largest value among even numbers equal to or less than a square root of the natural number and then search for respective square roots of the second square number, the third square number, and the fourth square number.

2. The information processing apparatus according to claim 1, wherein,
in a case where a value obtained by subtracting the first square number from the natural number is congruent to 1 or 5 modulo 8, the calculation unit limits a search range for the square root of the second square number to odd numbers and then determines search ranges for the respective square roots of the third square number and the fourth square number, on a basis of a resultant value obtained by dividing, by four, a value obtained by subtracting the first square number and the second square number from the natural number.

3. The information processing apparatus according to claim 2, wherein,
in a case where the resultant value obtained by dividing, by four, the value obtained by subtracting the first square number and the second square number from the natural number is a multiple of four, the calculation unit limits the search range for the square root of the second square number to odd numbers and limits search ranges for a coefficient for the square root of the third square number and a coefficient for the square root of the fourth square number to even numbers.

4. The information processing apparatus according to claim 2, wherein,
in a case where the resultant value obtained by dividing, by four, the value obtained by subtracting the first square number and the second square number from the natural number is congruent to 2 modulo 4, the calculation unit limits the search range for the square root of the second square number to odd numbers and limits search ranges for a coefficient for the square root of the third square number and a coefficient for the square root of the fourth square number to odd numbers.

5. The information processing apparatus according to claim 2, wherein,
in a case where the resultant value obtained by dividing, by four, the value obtained by subtracting the first square number and the second square number from the natural number is an odd number, the calculation unit limits search ranges for a coefficient for the square root of the third square number and a coefficient for the square root of the fourth square number to combinations of odd and even numbers.

6. The information processing apparatus according to claim 5, wherein,
in a case where a remainder when the value obtained by subtracting the first square number and the second square number from the natural number is divided by four is one and where a remainder when the value obtained by subtracting the first square number and the second square number from the natural number is divided by eight is one, the calculation unit limits the search range for one of the coefficient for the square root of the third square number and the coefficient for the square root of the fourth square number that is an even number, to multiples of four.

7. The information processing apparatus according to claim 5, wherein,
in a case where a remainder when the value obtained by subtracting the first square number and the second square number from the natural number is divided by four is one and where a remainder when the value obtained by subtracting the first square number and the second square number from the natural number is divided by eight is five, the calculation unit limits the search range for one of the coefficient for the square root of the third square number and the coefficient for the square root of the fourth square number that is an even number, to values that do not include multiples of four.

8. The information processing apparatus according to claim 1, wherein,
in a case where a value obtained by subtracting the first square number from the natural number is congruent to 3 or 7 modulo 8, the calculation unit limits search ranges for the square root of the second square number, the square root of the third square number, and the square root of the fourth square number to odd numbers.

9. The information processing apparatus according to claim 1, wherein,
in a case where a bit length of the natural number is equal to or less than a first threshold, the calculation unit performs a calculation by using a first method for calculating, as the square root of the first square number, the largest value or the value smaller by two than the largest value among the even numbers equal to or less than the square root of the natural number.

10. The information processing apparatus according to claim 9, wherein,
in a case where the bit length of the natural number exceeds the first threshold, the calculation unit performs a calculation by using a second method for searching for the respective square roots of the first square number, the second square number, the third square number, and the fourth square number with use of a randomized algorithm.

11. The information processing apparatus according to claim 10, wherein
the first threshold is set on a basis of a bit length at which a calculation time taken in a case where the first method is used and a calculation time taken in a case where the second method is used are substantially identical to each other.

12. The information processing apparatus according to claim 11, wherein,
in a case where the bit length of the natural number is less than a second threshold that is set on a basis of the first threshold, the calculation unit adds a delay such that the calculation time approximates to a calculation time set in advance with respect to the second threshold, and then outputs a result of the calculation using the first method.

13. The information processing apparatus according to claim 11, wherein,
in a case where the bit length of the natural number is equal to or greater than a second threshold that is set on a basis of the first threshold but equal to or less than the first threshold, the calculation unit adds a random delay in a similar to the second method and then outputs a result of the calculation using the first method.

14. The information processing apparatus according to claim 11, wherein,
in a case where the bit length of the natural number exceeds the first threshold and where the calculation using the second method is completed earlier than a predetermined time, the calculation unit adds a delay on an order of ((log n)²/(log log n)) (where n represents the natural number) and then outputs a result of the calculation using the second method.

15. The information processing apparatus according to claim 10, wherein
the calculation unit adds a delay on a basis of a calculation time required in a case where the bit length of the natural number has a predetermined value, and then outputs a result of the calculation using the first method or the second method.

16. The information processing apparatus according to claim 1, wherein
the calculation unit performs a calculation by using, as the natural number, a difference between a received comparison value and a predetermined confidential value.

17. The information processing apparatus according to claim 16, wherein
the first square number, the second square number, the third square number, and the fourth square number that are output by the calculation unit are used to verify the confidential value.

18. An information processing method comprising:
by a processor,
performing a calculation to express a certain natural number by a sum of a first square number, a second square number, a third square number, and a fourth square number, wherein
the performing the calculation further includes calculating, as a square root of the first square number, a largest value or a value smaller by two than the largest value among even numbers equal to or less than a square root of the natural number and then searching for respective square roots of the second square number, the third square number, and the fourth square number.

19. A program for causing a computer to function as:
an information processing apparatus including
a calculation unit that performs a calculation to express a certain natural number by a sum of a first square number, a second square number, a third square number, and a fourth square number,
the calculation unit being configured to calculate, as a square root of the first square number, a largest value or a value smaller by two than the largest value among even numbers equal to or less than a square root of the natural number and then search for respective square roots of the second square number, the third square number, and the fourth square number.
